(19) United States
(12) Patent Application Publication
(10) Pub. No.: US 2009/0308197 A1
(43) Pub. Date: Dec. 17, 2009

(54) Friction Based Actuator Having Many Degrees of Freedom

(76) Inventor: Brian Dean Saunders, Amity, OR (US)

Correspondence Address: Brian Saunders, 17401 SE Walnut Grove Ln, Amity, OR, 97101, US

(21) Appl. No.: 12/362,488

(22) Filed: Apr. 10, 2009

Related U.S. Application Data
(60) Provisional application No. 61/024,486, filed on Jan. 29, 2008.

(51) Int. Cl. F16H 37/06

(52) U.S. Cl. 74/665 B

(57) ABSTRACT

It's a highly compact actuator with multiple outputs able to transfer force to those outputs in nearly any combination. The underlying technology, which I call a “differentiated clutch”, may have other applications as well. As such, those skilled in the art will appreciate that the conception, upon which this disclosure is based, may readily be utilized as a basis for the designing of other structures, methods and systems for carrying out the several purposes of the present invention. It is important, therefore, that any claims be regarded as including such equivalent constructions insofar as they do not depart from the spirit and. scope of the present invention.

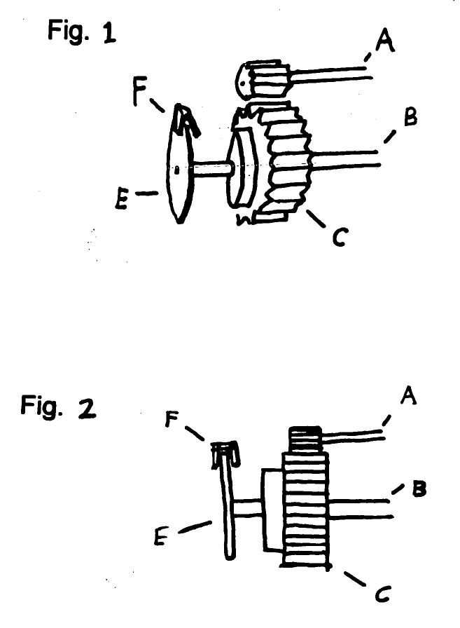

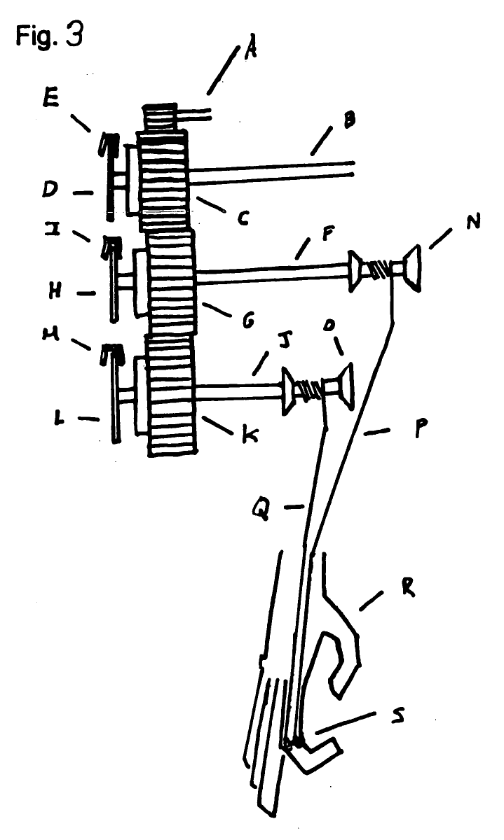

### DESCRIPTION OF THE SEVERAL VIEWS OF THE DRAWINGS

### 1-2

1A—Depicts an axle with a small gear attached to the end.

1B—Depicts an axle

1C—Depicts a differential gear assembly having one input and two outputs, and capable of distributing torque between the two outputs. It has gear teeth surrounding its exterior in order to act as the input.

1D—Depicts an axle

1E—Depicts the disc component of a disc and caliper braking system

1F—Depicts the caliper component of a disc and caliper braking system

### 2-2

2A—Depicts an axle with a small gear attached to the end.

2B—Depicts an axle

2C—Depicts a differential gear assembly having one input and two outputs, and capable of distributing torque between the two outputs. It has gear teeth surrounding its exterior in order to act as the input.

2D—Depicts the disc component of a disc and caliper braking system

2E—Depicts the caliper component of a disc and caliper braking system

2F—Depicts an axle

2G—Depicts a differential gear assembly having one input and two outputs, and capable of distributing torque between the two outputs. It has gear teeth surrounding its exterior in order to act as the input.

2H—Depicts the disc component of a disc and caliper braking system

2I—Depicts the caliper component of a disc and caliper braking system

2J—Depicts an axle

2K—Depicts a differential gear assembly having one input and two outputs, and capable of distributing torque between the two outputs. It has gear teeth surrounding its exterior in order to act as the input.

2L—Depicts the disc component of a disc and caliper braking system

2M—Depicts the caliper component of a disc and caliper braking system

2N—Depicts a spool of string

2O—Depicts a spool of string

2P—Depicts a string extending from the spool of string depicted at 2N

2Q—Depicts a string extending from the spool of string depicted at 2O

2R—Depicts a robotic puppet hand

2S—Depicts a joint in a finger of the robotic puppet hand depicted at 2R. It has a pulley in it which is designed to cause the joint to contract when the string depicted at 2P is pulled, or to expand when the string depicted at 2Q is pulled.

### DETAILED DESCRIPTION OF THE INVENTION

The device itself consists in a plurality of differential gear sets, each having a single input and two outputs, and being of basically the same kind one could purchase from a hobby shop specializing in radio controlled cars, because the same kind of gear set that is typically used to drive the radio controlled car's wheels would be suitable for use in this device as well.

A plurality of these differential gear sets are arranged in series or parallel so that their input gears can all be driven by a single motivating device. In operation, their input gears should always move at some fixed ratio to the speed of the primary motivating device, and therefore at fixed ratios to each other as well. One output of each differential gear set is attached to a braking device, but otherwise left to spin freely. The remaining output of each differential gear set is used to drive a remote device, each driving a separate device, or a separate degrees of freedom of the same device, or a combination of both. Because each output is only capable of being driven in one direction, it may be necessary sometimes to arrange them in opposed pairs. This is fine, because nothing prevents them from spinning backwards when torque is not being distributed to them.

The depiction of the puppet hand at 2R on page 2-2 is intentionally vague. This is because the puppet hand is not actually a part of the device. The building and use of puppet hands is already a very well understood technology in the robotics industry. A great example would be Shadow Company's Shadow Hand. I am not trying to claim to have made any innovations to the hand itself, in any sense whatsoever. What I have invented is a better way of pulling the strings that operate that hand.

The inclusion of a depiction of a puppet hand at 2R on page 2-2 is only for the purpose of demonstrating that pulling the strings that operate a puppet hand is a potential application for the device.

The illustration on page 1-2 depicts a differential gear set having one input and two outputs. The input axle is depicted at 1A, and drives a small gear, which turn drives the larger set of gear teeth that surround to the differential gear assembly depicted at 1C. The output axle depicted at 1D is attached to the disc depicted at 1E, which is part of a disc and caliper brake system consisting of the disc depicted at 1E and the caliper depicted at 1F. The other axle depicted at 1B is the output axle of the device, and would normally be used to drive a remote device, or a degree of freedom of a remote device.

The illustration on page 2-2 depicts several examples of the device depicted on page 1-2, with their input gears connected to each other so they can all be driven by the axle depicted at 2A. Each is comprised of a differential gear assembly, depicted at 2C, 2G, and 2K, respectively, an output to the left leading to a disc and caliper brake system, each consisting of a disc depicted at 2D, 2H, and 2L, respectively, as well as a caliper depicted at 2E, 2I, and 2M, respectively, and an output axle to the right, depicted at 2B, 2F, and 2J, respectively.

The output axles depicted at 2F and 2J are attached to spools of string depicted at 2N and 2O. They can pull on the strings depicted at 2P an 2Q by spinning the spools. Both strings are attached to the same joint in a finger of a puppet hand, the joint depicted at 2S, of the puppet hand depicted at 2R. They are attached in such a manner so that pulling on the string depicted at 2P would motivate the joint to close, while pulling on the string depicted at 2Q would motivate the joint to expand. If torque is being applied to the axle depicted at 2A, then engaging the braking caliper depicted at 2I would motivate the axle depicted at 2F to spin the spool depicted at 2N, which would pull on the string depicted at 2P, motivating the joint depicted at 2S to close, while engaging the braking caliper depicted at 2M would motivate the axle depicted at 2J to spin the spool depicted at 2O, which would pull on the string depicted at 2Q, motivating the the joint depicted at 2S to expand.

The reason for including three outputs instead of just the two which are actually made use of is just to demonstrate that more than two outputs can be connected to a single input.

In operation, an external motivator drives the main input, which causes the separate input gears of each differential to spin, and then an operator can distribute torque to the separate outputs by engaging the brakes. If any given brake is left entirely unengaged, then the output that corresponds to that brake will have no torque distributed to it, or at most it will receive a very small amount of torque caused by the internal friction and inertia of the mechanical components. However it usually shouldn't be enough to make much of a difference, and a variety of different counter measures already familiar to the field of robotics can be introduced to minimize the effect. For example, a small amount of friction could be purposefully built into the output axles to counter any small amounts of force too weak to overcome their resistance to motion. If the materials used to create this friction have a much higher coefficient of static friction than their coefficient of sliding friction, then the amount of inefficiency introduced would be minimal.

The dynamics of the machine are best described by making an analogy to the plumbing system in a house. The water pump puts pressure in the water lines, and the valves in the sinks and showers of the house then steer or divert that pressure to where it is needed.

In this device, the primary motivator serves the same purpose as the water pump serves in a plumbing system, by adding mechanical energy to the system. The brakes operate by closing instead of opening, but otherwise serve the same purpose as the valves in the sinks and showers of the house. If one brake is closed more than another, then more mechanical energy is diverted to its corresponding output axle than is diverted to the other brake's corresponding output axle.

This means that there will be some loss of energy due to the friction of the brakes. However the same could be said of the rudder that steers a boat, or the wing flaps that steer an airplane, because these are also examples of control devices that operate in a purely resistive manner. In this device, the brakes are effectively being used to steer, or deflect, mechanical energy down the desired pathways.

1. The use of a differential gear assembly having one input and two outputs, being capable of distributing torque between the two outputs, and having a braking device attached to one of its outputs, as a means of regulating the transfer of mechanical energy between the input and the remaining output that does not have a brake attached to it.

2. A plurality of instances of the device described in claim #1, having each of their inputs connected in series or parallel to a single, common, motivating device.

3. Use of those outputs of the differential gear assemblies contained in an instance of the device described in claim #2 which are not connected to brakes as a means of manipulating a plurality of remote robotic devices, a plurality of degrees of freedom contained within a single remote robotic device, or a combination of both.
